(19) United States
(12) Patent Application Publication
(10) Pub. No.: US 2007/0268835 A1
(43) Pub. Date: Nov. 22, 2007

(54) Redundancy communication control system and redundancy communication control method

(75) Inventors: Takanobu Kashiwagi, Kato (JP); Masahiko Katada, Kato (JP); Katsufumi Onaka, Kato (JP); Yukio Sekiguchi, Kato (JP); Akira Nanba, Kato (JP); Hironao Konishi, Kato (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/519,055

(22) Filed: Sep. 12, 2006

(30) Foreign Application Priority Data
May 19, 2006 (JP) 2006-140484

(51) Int. Cl. H04J 3/14

(52) U.S. Cl. 370/242; 370/228

(57) ABSTRACT

A control unit for transmitting data to control the operation of a controlled unit transmits a command via a main control channel and a sub control channel. The controlled unit distinguishes via which channel of the main control channel and the sub control channel received data is received and determines whether received data maintains a constant value for a predetermined period of time or not. When it is determined that the received data maintains a constant value, data for distinguishing a channel via which data is received and data indicating that a failure has occurred in a channel are transmitted to the control unit via the other channel. Receiving data indicating that a failure has occurred, the control unit outputs data indicating that a failure has occurred to the outside, and transmits subsequent data using the sub control channel when a failure has occurred in the main control channel.

### CROSS-REFERENCE TO RELATED APPLICATIONS

This Nonprovisional application claims priority under 35 U.S.C. §119(a) on Patent Application No. 2006-140484 filed in Japan on May 19, 2006, the entire contents of which are hereby incorporated by reference.

### BACKGROUND OF THE INVENTION

The present invention relates to a redundancy communication control system and a redundancy communication control method in which a control unit and a controlled unit use a plurality of channels for data communication in a redundant manner, so that data communication is kept from being suspended even when a failure occurs in any of the channels.

In some systems in which a control unit and a controlled unit transmit and receive a command signal or the like for controlling the operation of the controlled unit, the controlled unit may be not allowed to become inoperative depending on the sort thereof. Included in such systems are, for example, a system such as a warning device of a security system which needs to be operated continuously for twenty four hours, a system such as a traffic control system the operation of which is not allowed to stop from a safety standpoint, a system such as a backup system of data which is not allowed to fail in data acquisition, and the like.

Such a system is usually provided with a redundancy communication control system for connecting a control unit and a controlled unit via a plurality of control channels and using one channel as a main control channel and the other as a sub control channel for command transmission in order to reliably transfer a command signal even when a communication failure of a command signal occurs. FIG. 1 is a block diagram showing the structure of a conventional redundancy communication control system.

As shown in FIG. 1, a command is transmitted from a control unit 1 via a main control channel 2 and a sub control channel 3 to a controlled unit 4. The controlled unit 4 applies data check to data received via the main control channel 2 and the sub control channel 3 respectively at data check circuits 41 and 41 such as parity check circuits and stores the data in receive buffers 42 and 42 when it is determined that the data is valid. The controlled unit 4 compares receive data, which are received via both channels and stored in the receive buffers 42 and 42, at a comparator circuit 43 so as to verify the consistency of the receive data in order to verify that both channels are functioning normally (see Japanese Patent Application Laid-Open No. H3-079135 (1991)). When both channels are functioning normally, a command is transmitted to an actuator 44 so as to cause a required operation.

### BRIEF SUMMARY OF THE INVENTION

The present invention has been made in view of the circumstances, and it is an object thereof to provide a redundancy communication control system and a redundancy communication control method which enable communication without any stop in data transmission and receipt even with a simple circuit structure.

In order to achieve the above object, a redundancy communication control system according to the first invention is a redundancy communication control system in which a controlled unit and a control unit for transmitting data to control an operation of the controlled unit are connected via a main control channel and a sub control channel, characterized in that the controlled unit comprises: receive channel distinguishing means for distinguishing via which channel of the main control channel and the sub control channel received data is received; determining means for determining whether received data maintains a constant value for a predetermined period of time or not; and failure data transmitting means for transmitting data for distinguishing a channel via which data is received and data indicating that a failure has occurred in said channel via the other channel to the control unit in case that the determining unit determines that the received data maintains a constant value, and the control unit comprises means for outputting data indicating that a failure has occurred to outside in case that data indicating that a failure has occurred is received and for transmitting subsequent data using the sub control channel in case that a failure has occurred in the main control channel.

The second invention relates to a redundancy communication control system according to the first invention, characterized in that the control unit further comprises means for transmitting predetermined data at a time interval shorter than the period of time.

The third invention relates to a redundancy communication control system according to the first invention or the second invention, characterized in that the controlled unit further comprises receive data specifying means for computing conjunction of data in a high state and data received via the other channel in case that data in a high state is received continuously for a predetermined period of time and for computing disjunction of data in a low state and data received via the other channel in case that data in a low state is received continuously for a predetermined period of time, when the control unit transmits identical data via the main control channel and the sub control channel simultaneously.

A redundancy communication control method according to the fourth invention is a redundancy communication control method for connecting a controlled unit and a control unit for transmitting data to control an operation of the controlled unit via a main control channel and a sub control channel and for controlling an operation of the controlled unit, characterized in that the method comprises the steps of distinguishing, with the controlled unit, via which channel of the main control channel and the sub control channel received data is received; determining, with the controlled unit, whether received data maintains a constant value for a predetermined period of time or not; transmitting, with the controlled unit, data for distinguishing a channel via which data is received and data indicating that a failure has occurred in said channel via the other channel to the control unit in case that it is determined that the received data maintains a constant value; outputting, with the control unit, data indicating that a failure has occurred to outside in case that data indicating that a failure has occurred is received; and transmitting, with the control unit, subsequent data using the sub control channel in case that a failure has occurred in the main control channel.

The fifth invention relates to a redundancy communication control method according to the fourth invention, characterized by further comprising the step of transmitting, with the control unit, predetermined data at a time interval shorter than the period of time.

The sixth invention relates to a redundancy communication control method according to the fourth invention or the fifth invention, characterized by further comprising the steps of computing, with the controlled unit, conjunction of data in a high state and data received via the other channel when data in a high state is received continuously for a predetermined period of time; and computing, with the controlled unit, disjunction of data in a low state and data received via the other channel in case that data in a low state is received continuously for a predetermined period of time, in a case where the control unit transmits identical data via the main control channel and the sub control channel simultaneously.

In the first invention and the fourth invention, a controlled unit and a control unit for transmitting data to control the operation of the controlled unit are connected via a main control channel and a sub control channel, so that the operation of the controlled unit is controlled. The controlled unit distinguishes via which channel of the main control channel and the sub control channel received data is received and determines whether received data maintains a constant value for a predetermined period of time or not. When it is determined that the received data maintains a constant value for a predetermined period of time, data indicating that a failure has occurred in a channel via which data is received is transmitted to the control unit. Receiving the data indicating that a failure has occurred, the control unit transmits subsequent data using the sub control channel when a failure has occurred in the main control channel and outputs data indicating that a failure has occurred in the sub control channel to outside when a failure has occurred in the sub control channel. In this manner, since the signal level of received data always varies during data communication, it can be determined that abnormality has occurred in communication using the channel when it is detected that the signal level is fixed at a high state or a low state for a certain period of time. Consequently, the normal/abnormal of a channel can be determined precisely in a simple circuit structure without the need to provide a comparator circuit of receive data, a circuit for determining whether received data is valid data or not and the like, and it becomes possible to realize redundancy communication without any stop in data communication.

In the second invention and the fifth invention, the control unit transmits predetermined data at a time interval shorter than the period of time. In this manner, by transmitting dummy data having a signal level which is not fixed at a high state or a low state for a certain period of time, for example, it becomes possible to avoid false recognition of a state in which no data is transmitted or received as a failure in a channel.

In the third invention and the sixth invention, in a case where the control unit transmits identical data via the main control channel and the sub control channel simultaneously, the controlled unit computes conjunction of data in a high state and data received via the other channel when data in a high state is received continuously for a predetermined period of time and computes disjunction of data in a low state and data received via the other channel when data in a low state is received continuously for a predetermined period of time. In this manner, since the signal level of received data always varies during data communication, it can be determined that abnormality has occurred in communication using the channel when it is detected that the signal level is fixed at a high state or a low state for a certain period of time. Consequently, by computing conjunction or disjunction of data respectively received via both channels when it is detected that the signal level is fixed at a high state or a low state for a certain period of time, it becomes possible to receive only valid data.

With the first invention and the fourth invention, since the signal level of received data always varies during data communication, it can be determined that abnormality has occurred in communication using the channel when it is detected that the signal level is fixed at a high state or a low state for a certain period of time. Consequently, the normal/abnormal of a channel can be determined precisely in a simple circuit structure without the need to provide a comparator circuit of receive data, a circuit for determining whether received data is valid data or not and the like, and it becomes possible to realize redundancy communication without any stop in data communication.

With the second invention and the fifth invention, by transmitting dummy data having a signal level which is not fixed at a high state or a low state for a certain period of time, for example, it becomes possible to avoid false recognition of a state in which no data is transmitted or received as a failure in a channel.

With the third invention and the sixth invention, since the signal level of received data always varies during data communication, it can be determined that abnormality has occurred in communication using the channel when it is detected that the signal level is fixed at a high state or a low state for a certain period of time. Consequently, by computing conjunction or disjunction of data respectively received via both channels when it is detected that the signal level is fixed at a high state or a low state for a certain period of time, it becomes possible to receive only valid data.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing the structure of a conventional redundancy communication control system;

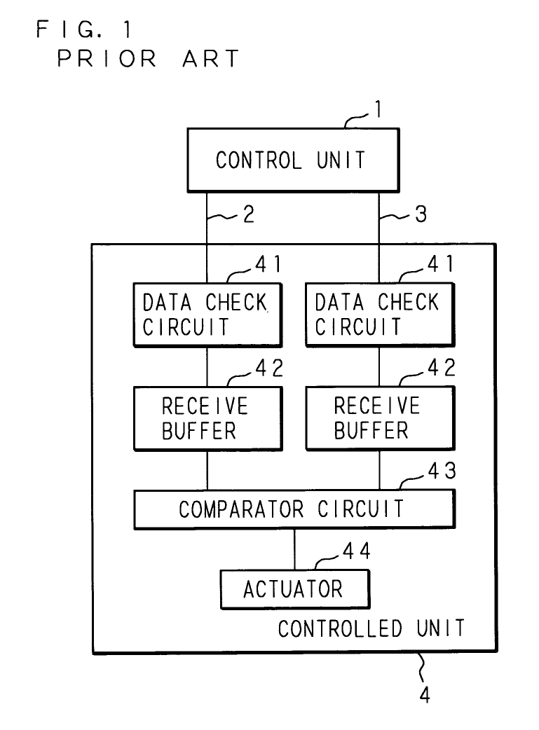

FIG. 2 is a block diagram showing the structure of a redundancy communication control system according to an embodiment of the present invention;

FIG. 3 is a flow chart showing the process procedure of a controlled unit of a redundancy communication control system according to an embodiment of the present invention;

FIG. 4A and FIG. 4B are a view showing an example of a receive data row to be received via a channel; and

FIG. 5A and FIG. 5B are a view for explaining the principle of a method for avoiding mistaken determination using dummy data.

### DETAILED DESCRIPTION OF THE INVENTION

In the conventional redundancy communication control system described above, when data is received simultaneously via the main control channel 2 and the sub control channel 3, it is necessary to determine whether both receive data is identical or not. In addition, it is also necessary to distinguish data received via which channel is valid data. For example, when data is received via both of the main control channel and the sub control channel and both data are compared by the comparator circuit 43 bringing the result that both data are different from each other, a circuit structure for determining which receive data is valid becomes complex in order to distinguish identification information embedded in header information of receive data, to obtain information relating send data from a sender and the like, and there is a problem that miniaturization, weight saving and the like of the device are difficult.

In addition, in order to simplify the circuit structure of the receiver, a hot standby system is employed for receiving data not via the main control channel 2 and the sub control channel 3 simultaneously but only via the main control channel 2 and switching to the sub control channel 3 once a failure occurs in the main control channel 2. In this case, there still is a problem that data cannot be received once a failure occurs in the main control channel 2 when a failure has already occurred in the sub control channel 3 and redundancy becomes meaningless.

The present invention has been made in view of the circumstances, and it is an object thereof to provide a redundancy communication control system and a redundancy communication control method which enable communication without any stop in data transmission and receipt even with a simple circuit structure. The following description will explain the present invention in detail with reference to the drawings illustrating an embodiment thereof.

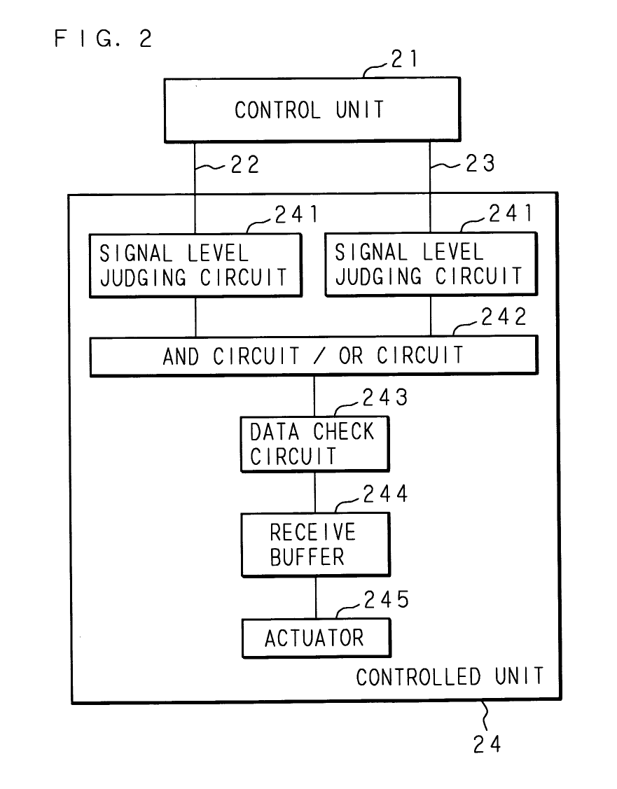

FIG. 2 is a block diagram showing the structure of a redundancy communication control system according to an embodiment of the present invention. In a redundancy communication control system according to an embodiment of the present invention, as shown in FIG. 2, a control unit 21 for transmitting a command signal to control the operation of a controlled unit 24 is connected with the controlled unit 24 via a main control channel 22 and a sub control channel 23 so as to be capable of data communication.

The control unit 21 at least comprises a processor such as an LSI and transmits a command signal to the controlled unit 24 via the main control channel 22 or the sub control channel 23, or via the main control channel 22 and the sub control channel 23.

By transmitting a command signal via the main control channel 22 and/or the sub control channel 23, the control unit 21 makes the command transmission redundant. Command transmission is classified broadly into two types. One is a dual type to send a command simultaneously to both of the main control channel 22 and the sub control channel 23, and the other is a hot standby type to send a command only to the main control channel 22 and send a command to the sub control channel 23 only when a failure occurs in the main control channel 22.

The controlled unit 24 at least comprises: signal level judging circuits 241 and 241 for examining the signal level of received data; an AND circuit or OR circuit 242 for computing conjunction or disjunction of received data; a data check circuit 243; a receive buffer 244; and an actuator 245 for causing the controlled unit 24 to perform a required operation.

The controlled unit 24 examines the signal level of data received via the main control channel 22 and/or the sub control channel 23 at the signal level judging circuits 241 and 241. When a failure occurs in the main control channel 22 or the sub control channel 23, the signal level of the received data becomes constant at a high state (for example, “1”) or a low state (for example, “0”). Consequently, the controlled unit 24 can determine in which channel a failure has occurred, by examining the signal level.

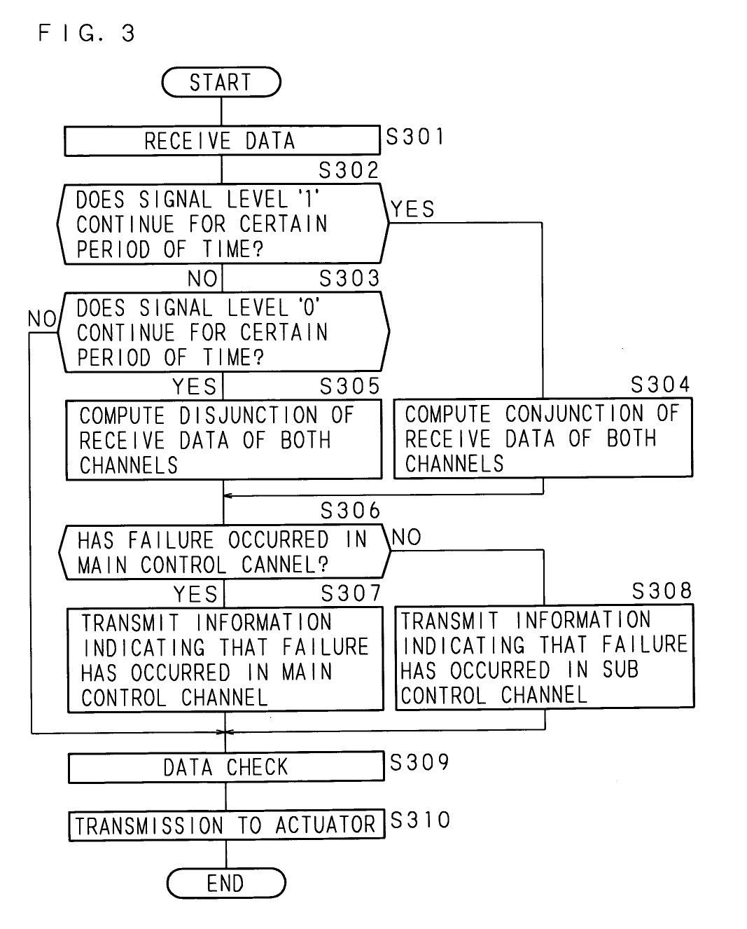

FIG. 3 is a flow chart showing the process procedure of the controlled unit 24 of a redundancy communication control system according to an embodiment of the present invention. The controlled unit 24 receives data via the main control channel 22 and/or the sub control channel 23 at the signal level judging circuits 241 and 241 (step S301) and determines whether the signal level of the received data maintains a high state, e.g. “1”, for a certain period of time or not (step S302). When the controlled unit 24 determines that the signal level maintains “1” for a certain period of time (step S302: YES), the controlled unit 24 computes conjunction of data received via both channels, with an AND circuit 242 (step S304). That is, the controlled unit 24 computes conjunction of data the signal level of which maintains “1” for a certain period of time and data received via a normal channel so as to obtain normal receive data.

When the controlled unit 24 determines that the signal level does not maintain “1” for a certain period of time (step S302: NO), the controlled unit 24 determines whether the signal level of the received data maintains a low state, e.g. “0”, for a certain period of time or not (step S303). When the controlled unit 24 determines that the signal level maintains “0” for a certain period of time (step S303: YES), the controlled unit 24 computes disjunction of data received via both channels, with an OR circuit 242 (step S305). That is, the controlled unit 24 computes disjunction of data the signal of which maintains “0” for a certain period of time and data received via a normal channel so as to obtain normal receive data.

It should be noted that the AND circuit or OR circuit 242 is not essential, and only data received via a channel which is determined to be normal may be sent to the data check circuit 243 after distinguishing which channel is normal.

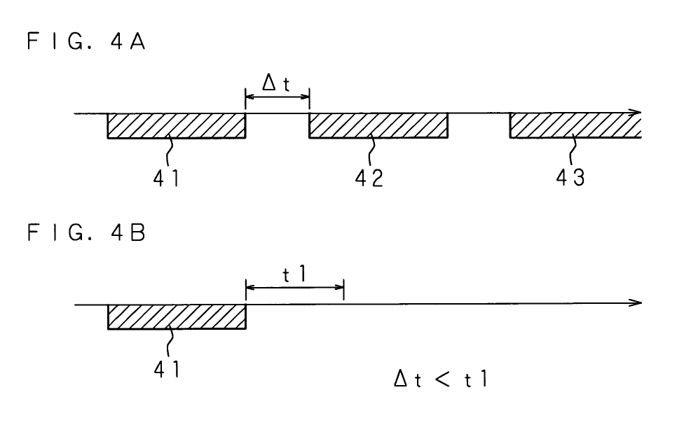

FIG. 4 is a view showing an example of a receive data row to be received via a channel. When a channel is normal as shown in FIG. 4A, received receive data rows 41, 42, 43, . . . , e.g. receive packets or receive frames, are received continuously at a certain time interval. In contrast, when a failure occurs in the main control channel 22, for example, as shown in FIG. 4B, receive data rows to be received, e.g. receive packets or receive frames, end at a receive data row 41 and the next receive data rows 42, 43, . . . are never received even when a time interval, at which time interval receive data rows have been received continuously, passes.

Therefore, the controlled unit 24 determines whether the signal level of data received via the main control channel 22 and/or the sub control channel 23 maintains a high state or a low state continuously for a certain period of time or not at the signal level judging circuits 241 and 241. In particular, determined after reception of a receive data row 41 ends is whether a period of time for which the signal level maintains a certain value, e.g. “1” or “0”, has reached a period of time t1 which is longer than a reception time interval Δt of a case where a receive data row is received normally or not, and it is determined that some failure has occurred in the channel when said period of time has reached the period of time t1.

The controlled unit 24 determines whether a failure has occurred in the main control channel 22 or not (step S306). When the controlled unit 24 determines that a failure has occurred in the main control channel 22 (step S306: YES), the controlled unit 24 transmits information indicating that a failure has occurred in the main control channel 22 to the control unit 21 (step S307). When the controlled unit 24 determines that a failure has occurred in the sub control channel 23 (step S306: NO), the controlled unit 24 transmits information indicating that a failure has occurred in the sub control channel 23 to the control unit 21 (step S308). In which channel a failure has occurred is transmitted to the control unit 21 by, for example, transmitting a channel ID or the like for distinguishing a channel.

Receiving information indicating that a failure has occurred in the main control channel 22, the control unit 21 switches a data transmission channel to the sub control channel 23. Receiving information indicating that a failure has occurred in the sub control channel 23, the control unit 21 announces that a failure has occurred in the sub control channel 23 by display output to the outside or the like. In this manner, the sub control channel 23 can be repaired immediately and it becomes possible to prevent such a situation that data transmission and reception stop due to occurrence of a failure in the main control channel 22.

When the controlled unit 24 determines that the signal level does not maintain “0” for a certain period of time (step S303: NO), the controlled unit 24 determines that both channels function normally and executes a parity check or the like with the data check circuit 243 for received data, or receive data received via the AND circuit or OR circuit 242, so as to verify the consistency of the receive data (step S309). The controlled unit 24 temporarily stores data after the termination of data check in the receive buffer 244, reads out necessary data from the receive buffer 244 according to each actuator 245 and transmits the data to the corresponding actuator 245 (step S310). Each actuator 245 applies command analysis to received data and makes an operation according to designation to be performed.

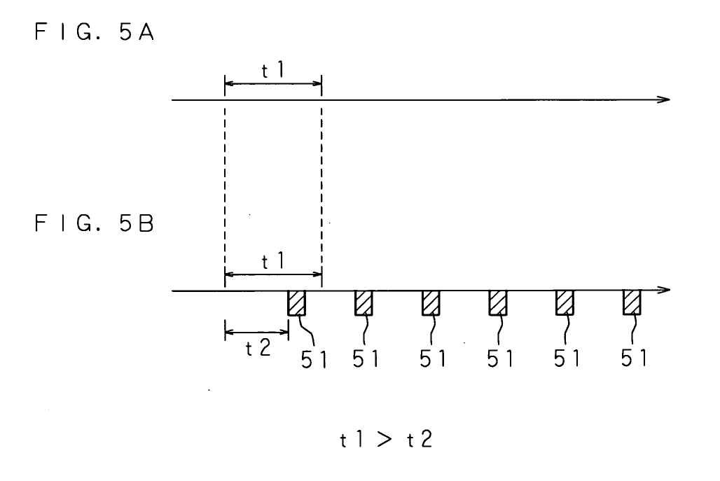

It is preferable to avoid mistakenly determining that a channel failure has occurred while communication is not performed. Therefore, the control unit 21 transmits dummy data which makes it possible to detect variation of the signal level at a certain time interval t2. FIG. 5 is a view for explaining the principle of a method for avoiding mistaken determination using dummy data.

While communication is not performed as shown in FIG. 5A, the signal level usually maintains a “0” state. Consequently, when a certain period of time t1 passes, the controlled unit 24 mistakenly determines that a failure has occurred in the channel in the process described above.

Therefore, while communication is not performed, the control unit 21 transmits dummy data 51, 51, . . . having a signal level of “1” at a time interval t2 (t1>t2). The controlled unit 24 never fails to detect dummy data 51 even when communication is not performed and can avoid mistaken determination. It should be noted that the timing for starting transmission of dummy data 51, 51, . . . is not limited especially, and transmission may be started at the timing when the connection of communication is opened, and stopped at the timing when connection is established, for example.

With the present embodiment, as described above, since the signal level of received data always varies while data communication is performed, it is possible to determine that abnormality has occurred in communication using the channel when it is detected that the signal level is fixed at a high state or a low state for a certain period of time. Consequently, the normal/abnormal of a channel can be determined precisely in a simple circuit structure without the need to provide a comparator circuit of receive data, a circuit for determining whether received data is valid data or not and the like, and it becomes possible to realize redundancy communication without any stop in data communication. In addition, by transmitting dummy data having a signal level which is not fixed at a high state or a low state for a certain period of time, for example, it becomes possible to avoid false recognition of a state in which no data is transmitted or received as a failure in a channel.

It should be noted that a plurality of controlled units 24, 24, . . . may be connected for one control unit 21 although the embodiment described above explains a case where one controlled unit 24 is connected for one control unit 21. It should be understood that the cost-down effect is enhanced by simplifying the circuit structure of the controlled units 24, 24, . . . .

In addition, the main control channel 22 and the sub control channel 23 are not limited to correspond to the serial transmission system, and the same effect can be expected in a case where the channels correspond to the parallel transmission system, for example.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A redundancy communication control system comprising a controlled unit and a control unit for transmitting data to control an operation of the controlled unit, in which the controlled unit and the control unit are connected via a main control channel and a sub control channel, wherein
the controlled unit comprises:
receive channel distinguishing means for distinguishing via which channel of the main control channel and the sub control channel received data is received;
determining means for determining whether received data maintains a constant value for a predetermined period of time or not; and
failure data transmitting means for transmitting data for distinguishing a channel via which data is received and data indicating that a failure has occurred in said channel via the other channel to the control unit in case that the determining means determines that the received data maintains a constant value, and
the control unit comprises
means for outputting data indicating that a failure has occurred to outside in case that data indicating that a failure has occurred is received and for transmitting subsequent data using the sub control channel in case that a failure has occurred in the main control channel.

2. The redundancy communication control system according to claim 1, wherein the control unit further comprises means for transmitting predetermined data at a time interval shorter than the period of time.

3. The redundancy communication control system according to claim 1, wherein
the control unit transmits identical data via the main control channel and the sub control channel simultaneously, and
the controlled unit further comprises
receive data specifying means for computing conjunction of data in a high state and data received via the other channel in case that data in a high state is received continuously for a predetermined period of time and for computing disjunction of data in a low state and data received via the other channel in case that data in a low state is received continuously for a predetermined period of time.

4. The redundancy communication control system according to claim 2, wherein
the control unit transmits identical data via the main control channel and the sub control-channel simultaneously, and
the controlled unit further comprises
receive data specifying means for computing conjunction of data in a high state and data received via the other channel in case that data in a high state is received continuously for a predetermined period of time and for computing disjunction of data in a low state and data received via the other channel in case that data in a low state is received continuously for a predetermined period of time.

5. A redundancy communication control system comprising a controlled unit and a control unit for transmitting data to control an operation of the controlled unit, in which the controlled unit and the control unit are connected via a main control channel and a sub control channel, wherein
the controlled unit comprises a processor capable of performing the steps of:
distinguishing via which channel of the main control channel and the sub control channel received data is received;
determining whether received data maintains a constant value for a predetermined period of time or not; and
transmitting data for distinguishing a channel via which data is received and data indicating that a failure has occurred in said channel via the other channel to the control unit in case that it is determined that the received data maintains a constant value, and
the control unit comprises a processor capable of performing the step of:
outputting data indicating that a failure has occurred to outside when data indicating that a failure has occurred is received and transmitting subsequent data using the sub control channel in case that a failure has occurred in the main control channel.

6. The redundancy communication control system according to claim 5, wherein the control unit further comprises a processor capable of performing the step of transmitting predetermined data at a time interval shorter than the period of time.

7. The redundancy communication control system according to claim 5, wherein
the control unit transmits identical data via the main control channel and the sub control channel simultaneously, and
the controlled unit further comprises a processor capable of performing the step of:
computing conjunction of data in a high state and data received via the other channel in case that data in a high state is received continuously for a predetermined period of time and computing disjunction of data in a low state and data received via the other channel in case that data in a low state is received continuously for a predetermined period of time.

8. The redundancy communication control system according to claim 6, wherein
the control unit transmits identical data via the main control channel and the sub control channel simultaneously, and
the controlled unit further comprises a processor capable of performing the step of:
computing conjunction of data in a high state and data received via the other channel in case that data in a high state is received continuously for a predetermined period of time and computing disjunction of data in a low state and data received via the other channel in case that data in a low state is received continuously for a predetermined period of time.

9. A redundancy communication control method using a controlled unit and a control unit for transmitting data to control an operation of the controlled unit, in which the controlled unit and the control unit are connected via a main control channel and a sub control channel, wherein
the method comprises the steps of:
distinguishing, with the controlled unit, via which channel of the main control channel and the sub control channel received data is received;
determining, with the controlled unit, whether received data maintains a constant value for a predetermined period of time or not;
transmitting, with the controlled unit, data for distinguishing a channel via which data is received and data indicating that a failure has occurred in said channel via the other channel to the control unit in case that it is determined that the received data maintains a constant value; and
outputting, with the control unit, data indicating that a failure has occurred to outside in case that data indicating that a failure has occurred is received and transmitting, with the control unit, subsequent data using the sub control channel in case that a failure has occurred in the main control channel.

10. The redundancy communication control method according to claim 9, further comprising the step of transmitting, with the control unit, predetermined data at a time interval shorter than the period of time.

11. The redundancy communication control method according to claim 9, further comprising the steps of:
transmitting, with the control unit, identical data via the main control channel and the sub-control channel simultaneously: and
computing, with the controlled unit, conjunction of data in a high state and data received via the other channel in case that data in a high state is received continuously for a predetermined period of time and computing, with the controlled unit, disjunction of data in a low state and data received via the other channel in case that data in a low state is received continuously for a predetermined period of time.

12. The redundancy communication control method according to claim 10, further comprising the steps of:
transmitting, with the control unit, identical data via the main control channel and the sub control channel simultaneously: and
computing, with the controlled unit, conjunction of data in a high state and data received via the other channel in case that data in a high state is received continuously for a predetermined period of time and computing, with the controlled unit, disjunction of data in a low state and data received via the other channel in case that data in a low state is received continuously for a predetermined period of time.
